(19) United States
(12) Patent Application Publication
(10) Pub. No.: US 2019/0271298 A1
(43) Pub. Date: Sep. 5, 2019

(54) ROTOR BLADE ASSEMBLY

(71) Applicant: Siemens Gamesa Renewable Energy A/S, Brande (DK)

(72) Inventors: Uffe Eriksen, Horsens (DK); Jens Hald Jensen, Give (DK); Jesper Bjerre Pedersen, Torring (DK); Jeppe Soee, Ronde (DK)

(21) Appl. No.: 16/343,451

(22) PCT Filed: Oct. 19, 2017
(86) PCT No.: PCT/EP2017/076683

§ 371 Date: Apr. 19, 2019

(30) Foreign Application Priority Data
Nov. 11, 2016 (DE) 10 2016 222 209.0

(51) Int. Cl. F03D 13/10; B66C 1/10; B66C 1/62

(52) U.S. Cl. CPC F03D 13/10; B66C 1/108; F05B 2240/30; F05B 2230/61; B66C 1/62

(57) ABSTRACT

Provided is a wind turbine rotor blade assembly including a rotor blade with an airfoil section and a root section; a carrier assembly arranged in an interior cavity of the blade and including a number of lifting fittings, wherein a lifting fitting and adapted to engage with a connector of a blade lifting apparatus. A method of lifting a wind turbine rotor blade is also provided.

### CROSS-REFERENCE TO RELATED APPLICATIONS

This application claims priority to PCT Application No. PCT/EP/2017/076683, having a filing date of Oct. 19, 2017, which is based off of DE Application No. 10 2016 222 209.0, having a filing date of Nov. 11, 2016, the entire contents both of which are hereby incorporated by reference.

### FIELD OF TECHNOLOGY

The following describes a wind turbine rotor blade assembly, and a method of lifting a wind turbine rotor blade.

### BACKGROUND

The rotor blades of a wind turbine may need to be lifted or moved at various stages. For example, a new rotor blade may need to be moved around within a manufacturing facility; a rotor blade may be transferred from a storage facility to a transport means; a rotor blade may be lifted from ground level in order to connect it to the wind turbine hub; a damaged or defective rotor blade may be lowered to ground level after disconnecting it from the hub. Such lifting and handling maneuvers are fairly straightforward in the case of short and relatively light rotor blades of small-scale or medium-scale wind turbines. However, a long rotor blade with a length in the region of 90-130 m or more and a weight in the order of 50,000-100,000 kg is correspondingly more difficult to handle. Wind turbines with power ratings in the region of 10-20 MW require such large blades to extract the required energy from the wind.

To lift or handle such a long and heavy blade, a lifting yoke may be used, with a fastening system that grasps the blade around its perimeter in at least two locations to keep the blade securely attached to the lifting yoke during a handling maneuver. The fastening system is secured about the airfoil portion of the blade, which is generally several meters above the ground in the case of a long rotor blade, even when the blade is resting at ground level. During the attachment procedure, great care must be taken to avoid damage to the outer blade surface. In one approach, such a lifting yoke can be secured to the blade manually by a technician who arranges straps or slings of a fastening system around the outside of the blade. Ladders or similar access means are not suitable, since these might damage the blade surface. Therefore, this approach requires having to lift the technician up to the outside of the blade in a man basket, which adds to the risk of accident during the attachment procedure. Alternatively, an automated fastening system may be provided. However, any added levels of automation and complexity are generally associated with increased risk of breakdown or malfunction, causing delays to the installation work.

### SUMMARY

An aspect relates to provide an improved way of handling wind turbine rotor blades.

According to embodiments of the invention, the wind turbine rotor blade assembly comprises a rotor blade for connection to a hub of a wind turbine, and a carrier assembly arranged in an interior cavity of the rotor blade at a point within the airfoil section of the blade. The carrier assembly comprises a number of lifting fittings, and a lifting fitting is adapted to engage with a connector of a blade lifting apparatus arranged or positioned on the outside of the blade during a lifting maneuver. A lifting fitting can be formed integrally with the carrier assembly or can be a part that is mounted to a body of the carrier assembly.

The inventive method of lifting a wind turbine rotor blade comprises the steps of providing a carrier assembly comprising a number of lifting fittings mounted to the carrier assembly, wherein a lifting fitting is adapted to engage with a connector of a blade lifting apparatus; arranging the carrier assembly in the interior cavity of the rotor blade; bringing the blade lifting apparatus into place on the exterior of the rotor blade; engaging a connector of a blade lifting apparatus to a lifting fitting; performing a blade lifting maneuver; and subsequently disengaging the connector of the blade lifting apparatus from the lifting fitting.

The inventive wind turbine rotor blade assembly allows a quick and safe connection between the blade and a lifting apparatus. Since the carrier assembly and lifting fittings are arranged in the interior of the blade, so that the weight of the blade will be borne to a large extent by the lifting fittings and carrier assembly inside the blade, a lifting apparatus need only be equipped with some way of engaging to the lifting fittings. Since the carrier assembly and lifting fittings do not come into contact with the blade outer surface during the inventive method, the inventive blade lifting apparatus can be manufactured at lower cost compared with prior art blade lifting apparatus, for which care must be taken for parts that make contact with a rotor blade outer surface. The costs of blade lifting maneuvers can therefore be favorably reduced by the inventive method. Furthermore, the inventive assembly means that there is no need for a technician to use a man-basket in order to secure the lifting apparatus to the blade. This reduces the risk of accident during a setup or connecting step prior to a lifting maneuver, and during a release or disconnecting step following a lifting maneuver.

Without restricting embodiments of the invention in any way, it may be assumed in the following that the rotor blade has a length in the order of 90-130 m, a root end diameter in the order of 4-7 m, and a weight in the order of 50-100 metric tons. As indicated above, a rotor blade with such dimensions is large and unwieldy, and the known art lifting techniques are generally costly and involve hazardous steps.

The carrier assembly and lifting fittings are realized as one or more parts that have sufficient structural strength to bear the weight of the blade during a lifting maneuver. This is made possible due to a secure connection between the lifting fitting(s) and the connector(s) of the blade lifting apparatus. The blade and the blade lifting apparatus effectively act as one unit which then has a common center of mass when the blade lifting apparatus is hoisted into the air by a crane or other type of load lifting means. The “lifting point” of the blade may be understood to be the point of suspension of the total load, i.e. the blade and the blade lifting apparatus. A suitable position of the lifting point relative to the blade—e.g. essentially directly over the center of mass of the combined load—may be achieved by appropriate placement of the carrier assembly in the interior of the blade.

In an embodiment of the invention, the carrier assembly comprises one or more plates that are placed essentially orthogonally to a longitudinal axis of the rotor blade. The blade longitudinal axis may be the blade's axis of rotation when pitched, for example. The carrier assembly may fill a cross-sectional area of the blade, thereby engaging with the entire interior contour of the blade. Alternatively, in an embodiment of the invention, the carrier assembly only engages with the interior surface of the blade at two or more regions. In an embodiment of the invention, the carrier assembly comprises a relatively wide rim or collar that lies along the inside surface of the blade to achieve an even load distribution.

A carrier assembly can be arranged at any suitable position in the interior of the blade. For example, two carrier assemblies may be arranged at two separate positions inside the blade, for connection to a corresponding lifting apparatus that can engage with the lifting fittings of both carrier assemblies. However, in an embodiment of the invention, a single carrier assembly is used. A single carrier assembly can be arranged in the region of the center of mass of the rotor blade.

The connection between lifting fitting and lifting apparatus can be made in any number of ways. In one embodiment, a lifting fitting of the inventive assembly comprises a bushing to receive a bolt of the blade lifting apparatus. Alternatively, or in addition, a lifting fitting of the inventive assembly comprises a trunnion to receive a sling of the blade lifting apparatus. Alternatively, or in addition, a lifting fitting of the inventive assembly comprises a peg to fit into a tongue of the blade lifting apparatus. Of course, various other combinations of lifting fitting and connector are possible.

The rotor blade can be constructed to be connected to the hub by means of a root end flange that is bolted to a pitching mechanism. Such a blade can have an essentially empty interior extending most of the way into the blade. A carrier assembly of the inventive blade assembly can be realized as an arrangement of one or more solid steel plates, as a steel framework or in any other suitable manner and can be positioned at an appropriate point along the interior of the blade at some point along the airfoil section.

Another type of rotor blade can be constructed to fit over an inner shaft that is fixed to the hub, and which extends through the root section into the interior cavity of the rotor blade. An inner bearing at the root end between blade and shaft and an outer bearing at the shaft distal end between blade and shaft allow the blade to rotate about the fixed shaft during a pitching procedure. In an embodiment of the invention, the rotor blade assembly comprises such a shaft arranged to extend into the interior cavity of the rotor blade, and the carrier assembly is mounted in some suitable manner to the shaft. For example, the carrier assembly can be manufactured to fit over the shaft. A “root end” or inner end of the shaft is adapted for mounting to the hub, as will be known to the skilled person. In this embodiment, the carrier assembly is arranged at the outer end of the shaft (i.e. in the direction of the blade tip), for example at a position that is close to the center of mass of the blade.

A rotor blade assembly with such an inner shaft and bearing arrangement may generally make use of a blade adapter to hold the blade in place about the shaft, since the blade may be significantly wider than the shaft at the shaft outer end. In an embodiment of the invention, the carrier assembly can be mounted on the blade shaft at a suitable distance from the blade adapter. In this embodiment, the position of the lifting point is effectively independent of the length of the inner shaft. Alternatively, in a further embodiment of the invention, the carrier assembly and a blade adapter of the shaft end bearing are realized as a single unit. In such an embodiment, the blade adapter effectively acts as the carrier assembly. With relatively little effort, therefore, the blade adapter of an existing blade design may be equipped with lifting fittings to achieve an embodiment of the inventive blade assembly. In this embodiment, the position of the lifting point relative to the blade is effectively determined by the position of the blade adapter on the inner shaft.

The connectors of the lifting apparatus must enter the blade interior cavity in order to engage with the lifting fittings. Therefore, in an embodiment of the invention, the blade assembly comprises one or more access openings in the rotor blade body, arranged to provide access to the lifting fitting(s) in the interior cavity of the blade. The openings can be left open as long as the blade is being prepared for installation in order to facilitate lifting procedures at the manufacturing site, from a storage facility to a transport facility, etc. The access openings are closed again after a final lifting maneuver, for example when the blade is lifted for connection to the wind turbine hub. A suitable plug can be used to seal an access opening so that moisture cannot enter the blade.

### BRIEF DESCRIPTION

Some of the embodiments will be described in detail, with reference to the following figures, wherein like designations denote like members, wherein:

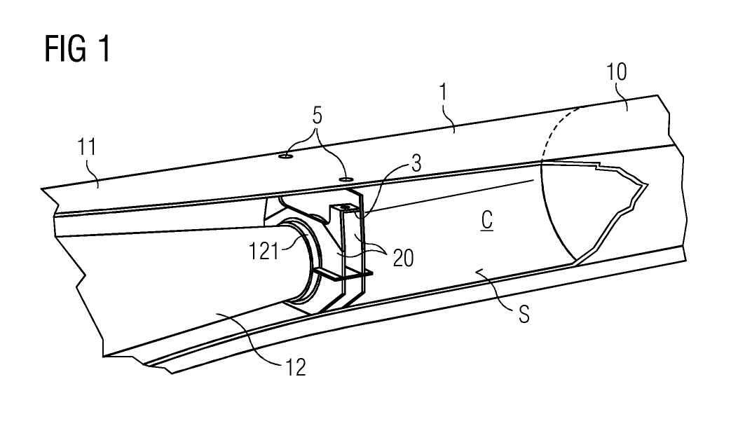

FIG. 1 shows a first embodiment of the inventive rotor blade assembly;

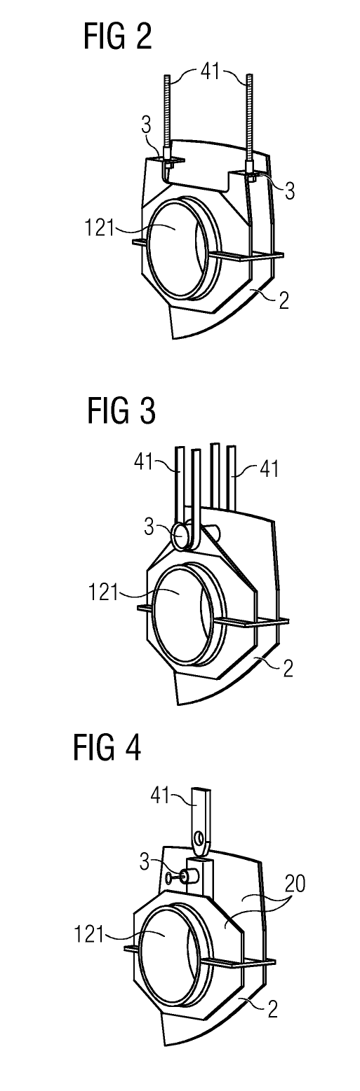

FIG. 2 shows a lifting fitting of a first embodiment of the inventive rotor blade assembly and its lifting apparatus counterpart;

FIG. 3 shows a lifting fitting of a second embodiment of the inventive rotor blade assembly and its lifting apparatus counterpart;

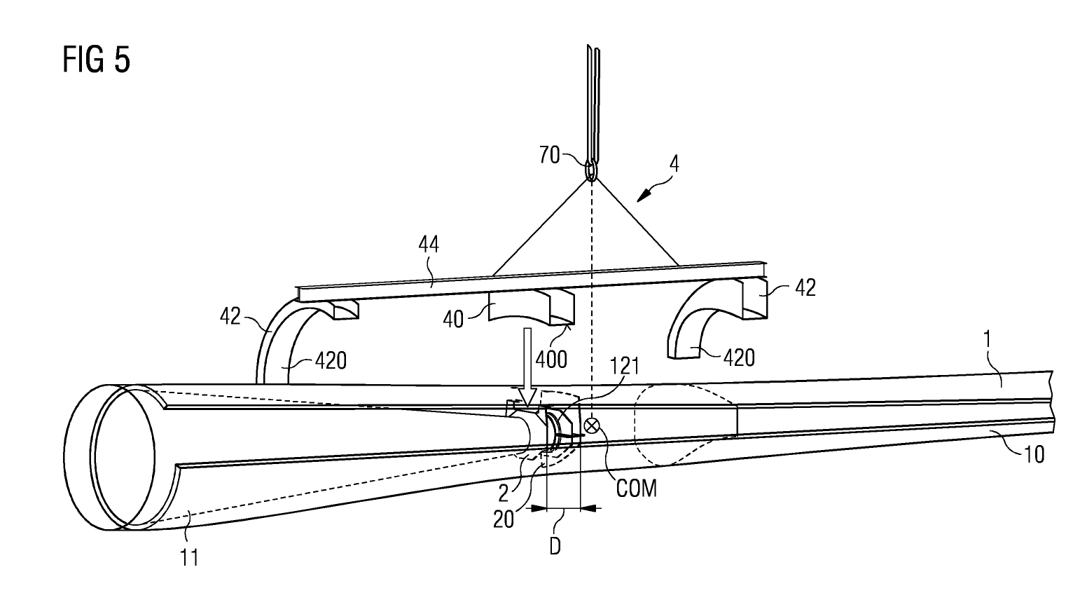

FIG. 4 shows a lifting fitting of a third embodiment of the inventive rotor blade assembly and its lifting apparatus counterpart;

FIG. 5 shows an exemplary embodiment of a lifting yoke for use with the inventive rotor blade assembly;

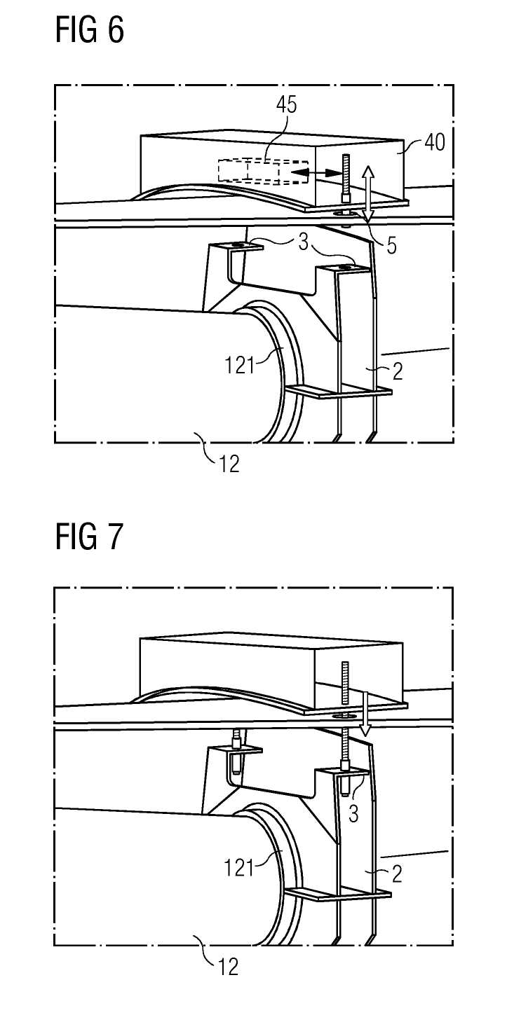

FIG. 6 shows stages in the inventive lifting method;

FIG. 7 shows stages in the connection of the main blade holder 40 of the lifting yoke 4 of FIG. 5 to the lifting fittings 3 of FIG. 2;

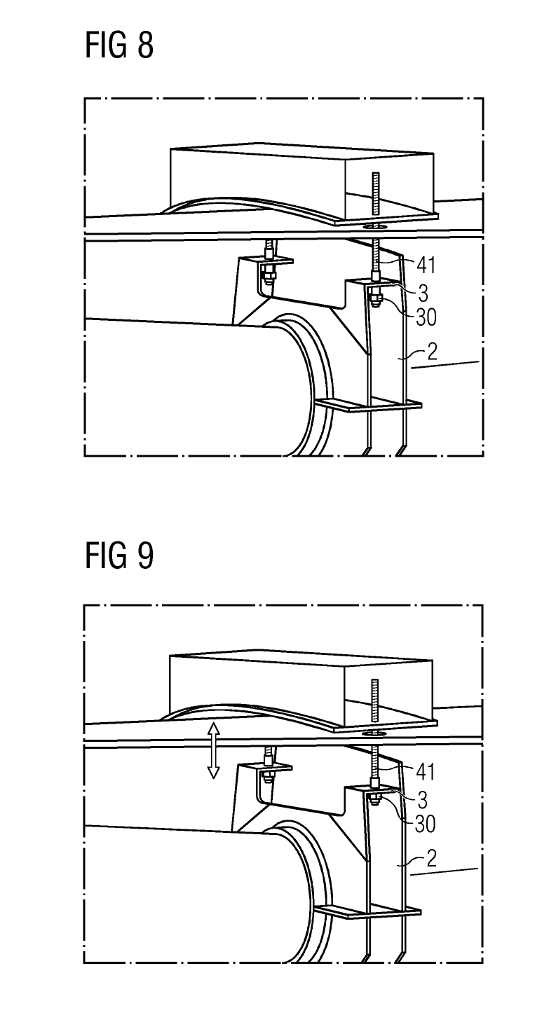

FIG. 8 shows stages in the connection of the main blade holder 40 of the lifting yoke 4 of FIG. 5 to the lifting fittings 3 of FIG. 2;

FIG. 9 shows stages in the connection of the main blade holder 40 of the lifting yoke 4 of FIG. 5 to the lifting fittings 3 of FIG. 2;

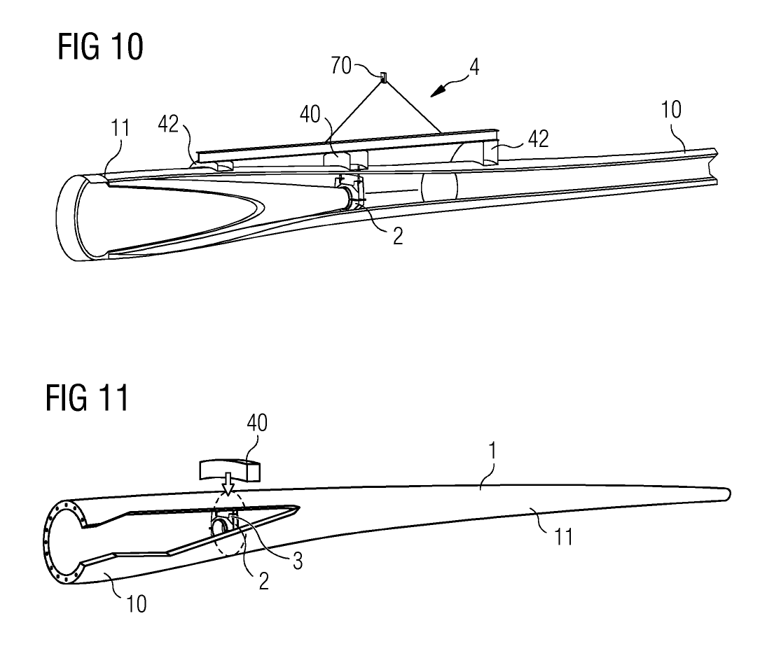

FIG. 10 is a cut-away diagram showing a blade 1 being lifted by a crane (not shown);

FIG. 11 is a cut-away diagram showing a blade 1 being lifted by a crane (not shown);

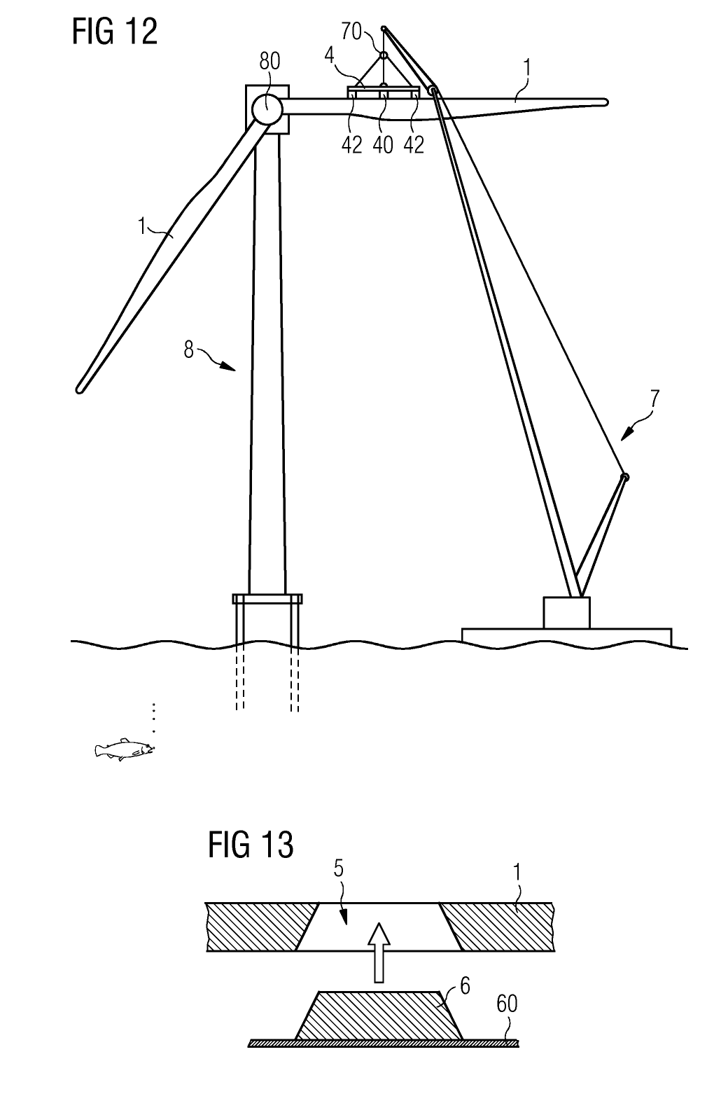

FIG. 12 shows an exemplary installation scenario, with a vessel-mounted crane 7 being used to install rotor blades 1 to an offshore wind turbine 8; and

FIG. 13 shows an exemplary step of sealing an access opening.

In the diagrams, like numbers refer to like objects throughout. Objects in the diagrams are not necessarily drawn to scale.

### DETAILED DESCRIPTION

FIG. 1 shows a first embodiment of the rotor blade assembly according to embodiments of the invention, and shows a view into the interior C of the blade 1 along a section of the blade's airfoil region. The diagram shows an outer end of a tapered shaft 12. The tapered shaft 12 extends from the blade's root end 10 some way into the blade interior C. In this embodiment, a bearing 121 is arranged around the shaft 12 towards its outer end, and the bearing 121 is realized as part of a single component that also includes a carrier assembly 2 for a number of lifting fittings 3. Here, the carrier assembly 2 comprises a pair of metal plates 20 shaped to engage with the inside surface(s) of the blade 1. The carrier assembly 2 also has a circular opening to enclose the bearing 121 and the shaft 12. In this embodiment, the carrier plates 20 are mounted to the bearing 121 as a single assembly, and the carrier assembly 2 effectively acts also as the blade adapter for this type of rotor blade 1. The diagram also shows access openings 5 in the upper surface of the blade 1 to permit access to the lifting fittings 3.

The other, inner end of the shaft is not shown, but it will be understood that the inner end or root end of the shaft engages with the blade root end by means of a root end bearing and a pitch system. When installed on the hub of a wind turbine, the inner shaft will extend outward from the hub and is stationary relative to the hub; and the rotor blade can be pitched by a pitch drive unit that turns the rotor blade about the inner shaft.

FIGS. 2-4 show various kinds of lifting fitting 3 and their lifting apparatus counterparts 41. In each case, appropriately shaped access openings in the upper surface of the blade will permit access to the lifting fittings 3. In FIG. 2, each lifting fitting 3 is a brace mounted to the carrier assembly 2 and the lifting apparatus connector 41 is a bolt with a threaded end. Each brace has a bushing or though-hole to accommodate such a bolt. Nuts 30 threaded onto the bolt ends complete the connection. In FIG. 3, each lifting fitting 3 is a trunnion, and each lifting apparatus connector 41 is a sling that can extend around a trunnion. In FIG. 4, the lifting fitting 3 is a pin or peg extending outward from a plate 20 of the carrier assembly 2, and the lifting apparatus connector 41 is a tongue with a through-hole through which the peg can extend.

FIG. 5 shows an exemplary embodiment of a lifting yoke 4. This comprises a long beam 44 which can be secured to the hook 7 of a crane (not shown) in the usual manner by means of cables or wires. The beam 44 is secured to a main blade holder 40 arranged towards the center of the beam 44, and also to two auxiliary blade holders 42 at each outer end of the beam 44. Tag lines at each outer end of the beam 44 can be used to control the orientation of a blade 1 during a lifting maneuver. The contact surface 400, 420 of each blade holder 40, 42 matches the shape of the blade 1 to be lifted. The contact surfaces 420 of the auxiliary blade holders 42 can be realized as friction pads to maintain a non-slip contact between blade holders and blade during a lifting procedure.

The diagram shows that the carrier assembly 2 and the blade adapter 20 of the shaft 12 are realized as separate entities. In this embodiment, the carrier assembly 2 is arranged around the shaft 12 and is positioned further inward (i.e. toward the root end) than the outer bearing 121, with a distance D between carrier assembly 2 and blade adapter 20. The distance D may be as large or as small as necessary to achieve a stable lifting point. This type of embodiment may be exemplary to allow more freedom in deciding where to place the carrier assembly 2, for example to achieve a lifting point (which may coincide with the crane hook as shown here) that is positioned directly above the center of mass of the combined blade/lifting apparatus, as indicated in the diagram. Another reason to manufacture the carrier assembly separately from the blade adapted may be to avoid making any structural alterations to an existing bearing/adapter design.

The exemplary embodiment shows that the main blade holder 40 comprises a pair of vertical bolts 41 extending downward. The bolt diameters and the bolt spacing are such to allow the bolts to extend through bushings of the lifting fitting of FIG. 2 as described above. The contact surfaces of the blade holders 40, 42 are lined with a foam material layer to avoid damage to the blade surface. When the shape of the auxiliary blade holders 42 closely matches the shape of the blade 1, no additional fasteners are needed for the auxiliary blade holders 42. Otherwise, a flexible band or sling may be used to extend from one end of an auxiliary blade holder 42, around the blade 1, and to the other end the auxiliary blade holder 42. The position of the main blade holder 40 along the beam 44 may be adjustable so that the lifting yoke 4 can safely handle blades of different length and weight. In this way, the position of the main blade holder 40 along the beam 44 can be chosen according to the location of the center of mass of the blade 1 in each case.

FIG. 6-9 show stages in the connection of the main blade holder 40 of the lifting yoke 4 of FIG. 5 to the lifting fittings 3 of FIG. 2. In this exemplary embodiment, the bolts are hydraulic bolts 41 with threaded outer ends, and the main blade holder 40 incorporates a driver module 45 arranged to apply tension to the bolts 41 or to release tension from the bolts 41 as required. In a first stage (top left), the main blade holder 40 is brought into position over access openings 5 in the blade 1, so that the bolts 41 are aligned with the bushings. These diagrams clearly show the lifting fittings 3 to be right-angled metal brackets 3 that extend between the two carrier plates 20 of the carrier 2. In a second stage (top right) the bolts 41 are being extended to pass through the bushings. In a third stage (bottom left), nuts 30 have been placed over the threaded ends of the bolts 41. To perform this action, a technician (not shown) enters the blade interior cavity C to access the lifting fittings 3. The nuts 30 need not be tightened; instead, it is sufficient to simply thread them onto the ends of the bolts 41. In a final stage (bottom right), the driver module 45 is controlled to apply tension to the hydraulic bolts 41. By tensioning the bolts 41, the blade 1 (via the carrier 2) and the main blade holder 40 are pulled towards each other as indicated by the arrow so that the contact surface of the main blade holder 40 lies snugly against the outer surface of the blade 1. This action also ensures that the blade is pressed against the contact surfaces of the auxiliary blade holders 42. The blade 1 is now ready for the lifting maneuver.

FIG. 10 is a cut-away diagram showing a blade 1 being lifted by a crane (not shown), using the lifting yoke 4 and the connector 41 of the main blade holder 40 connected to the lifting fittings 3 of the inventive rotor blade assembly. Although not shown in the diagram, it may be assumed that the rotor blade has been brought into a horizontal position at hub height, using a suitable crane such as a mobile crane (in the case of an on-shore installation procedure) or a vessel-mounted crane (in the case of an offshore installation procedure). While the blade is suspended in this horizontal position, an installation technician can enter the blade interior to detach the connector 41 from the carrier. The diagram also clearly shows a shaft 12 extending from the blade root end into the interior of the blade 1, and terminating at some point along the airfoil section 10 of the blade 1. A root end bearing 120 and an outer end bearing 121 will allow the blade 1 (after installation) to rotate about the fixed shaft 12 to adjust the blade pitch angle during operation of the wind turbine.

Since the blade root end 11 is generally heavy on account of its thickness, the shaft 12 is heavy since it is made of a structurally strong material such as steel, but the airfoil section 10 is thin and relatively light in spite of its length, the center of mass of the blade 1 can be located near the outer end of the shaft 12. This makes the position of the outer bearing 121 a good candidate for the carrier 2 of the inventive rotor blade assembly, and a bearing/blade adapter can simultaneously act as the carrier 2 for the lifting fitting(s) 3.

The root end diameter of the inner shaft 12 can be in the order of 4-7 m, while the diameter of the outer end of the inner shaft 12 can be in the order of 2-4 m. The inner shaft 12 is left open at its outer end so that a technician can enter the blade interior cavity C in order to access the lifting fittings 3 prior to the lifting maneuver (e.g. to place nuts over bolt ends, to arrange slings over trunnions, to fit a tongue over a horizontal pin, etc.) and to perform the reverse operation at the end of a lifting maneuver. The diagram also clearly shows that the weight of the blade 1 is held mainly by the main blade holder 40 and the lifting fitting connection, while the auxiliary blade holders 42 serve to stabilize the blade 1 during the lifting maneuver.

FIG. 11 shows an alternative embodiment of the inventive rotor blade assembly. Here, the cut-away diagram shows a blade 1 which can be lifted by a crane after connecting a main blade holder 40 of a lifting yoke 4 (not shown) to lifting fittings 3 mounted to a carrier 2 that is secured to the interior of the blade 1. In this diagram, the carrier 2 is shown as a vertical framework 2 that fits into the blade interior C, for example at a position near the center of mass of the blade 1. Lifting fittings 3 of the types described in FIGS. 2-4 can be mounted to the carrier 2.

FIG. 12 shows an exemplary installation scenario, with a vessel-mounted crane 7 being used to install rotor blades 1 to an offshore wind turbine 8. Each blade is installed by first attaching the blade yoke 4 to the blade 1 as described above (this can be performed at the level of the installation vessel), and then using the crane 7 to raise the blade 1 to hub height. After the blade 1 has been mounted to the hub 80, an installation technician can enter the blade 1 to detach the connector from the lifting fitting.

As described above, access openings are provided in the outer surface of the blade to allow connectors of the main blade holder to mate with the lifting fittings. Such access openings can be sealed using an appropriately shaped plug and/or an appropriate adhesive after completion of a final lifting maneuver, for example after the blade has been lifted into place and installed on the hub of a wind turbine. FIG. 13 shows an exemplary step of sealing an access opening 5. In this embodiment, the access opening 5 has been formed to have sloping side faces. An appropriately shaped plug 6 is being inserted into the access opening 5 from within the blade 1. The plug 6 fills the access opening 5 and can be secured in place by adhesive layers between the opposing side faces. An adhesive backing layer 60 may also be provided to provide additional adherence.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A wind turbine rotor blade assembly comprising
a rotor blade with an airfoil section and a root section;
a carrier assembly arranged in an interior cavity of the rotor blade and including a number of lifting fittings, wherein a lifting fitting is adapted to engage with a connector of a blade lifting apparatus.

2. The wind turbine rotor blade assembly according to claim 1, wherein the carrier assembly is shaped to engage with a surface of the interior cavity of the rotor blade.

3. The wind turbine rotor blade assembly according to claim 1, wherein the carrier assembly comprises a plate orthogonal to a longitudinal axis of the rotor blade.

4. The wind turbine rotor blade assembly according to claim 1, wherein the carrier assembly is arranged in the region of the center of mass of a load comprising at least the rotor blade.

5. The wind turbine rotor blade assembly according to claim 1, wherein a lifting fitting comprises a bushing to receive a bolt of the blade lifting apparatus and/or a lifting fitting comprises a trunnion to receive a sling of the blade lifting apparatus and/or a lifting fitting comprises a peg to fit into a tongue of the blade lifting apparatus.

6. The wind turbine rotor blade assembly according to claim 1, comprising a shaft arranged to extend into the interior cavity of the rotor blade, and wherein the carrier assembly is arranged on the shaft.

7. The wind turbine rotor blade assembly according to claim 6, comprising a shaft end bearing arranged about the outer end of the shaft, and wherein the carrier assembly and the shaft end bearing are realized in a single unit.

8. The wind turbine rotor blade assembly according to claim 6, comprising a shaft end bearing arranged about the outer end of the shaft, and wherein the carrier assembly is mounted on the shaft at a distance from the shaft end bearing.

9. The wind turbine rotor blade assembly according to claim 1, comprising an access opening in the rotor blade body, which access opening is arranged to provide access to the lifting fitting in the interior cavity of the rotor blade.

10. A blade lifting apparatus comprising
a lifting yoke realized for connection to a crane;
a main blade holder mounted to the lifting yoke and comprising at least one connector adapted to engage with a lifting fitting of a carrier assembly of a wind turbine rotor blade assembly according to claim 1.

11. The blade lifting apparatus according to claim 10, comprising a number of auxiliary blade holders mounted to the lifting yoke, and wherein a blade holder has a contact surface shaped to lie against an outer surface of a wind turbine rotor blade.

12. A method of lifting a wind turbine rotor blade, which method comprises the steps of
providing a carrier assembly including a number of lifting fittings, wherein a lifting fitting is adapted to engage with a connector of a blade lifting apparatus;
arranging the carrier assembly in an interior cavity of the rotor blade;
bringing the blade lifting apparatus into place at the exterior of the rotor blade;
engaging a connector of the blade lifting apparatus to a lifting fitting;
performing a blade lifting maneuver and subsequently disengaging the connector of the blade lifting apparatus from the lifting fitting.

13. The method according to claim 12, comprising a prior step of forming an access opening in the rotor blade to provide access to a lifting fitting arranged in the interior cavity of the rotor blade.

14. The method according to claim 13, comprising the step of sealing an access opening after completion of a blade lifting maneuver.

15. The method according to claim 12, wherein the step of engaging a connector of the blade lifting apparatus to the lifting fitting comprises extending a bolt into a bushing and/or arranging a sling around a trunnion and/or fitting a tongue over a peg.
